(19) United States
(12) Patent Application Publication
(10) Pub. No.: US 2026/0105693 A1
(43) Pub. Date: Apr. 16, 2026

(54) HIGH RESOLUTION TEXT-TO-3D CONTENT CREATION

(71) Applicant: NVIDIA Corporation, Santa Clara, CA (US)

(72) Inventors: Chen-Hsuan Lin, Santa Clara, CA (US); Tsung-Yi Lin, Sunnyvale, CA (US); Ming-Yu Liu, Redwood City, CA (US); Sanja Fidler, Toronto (CA); Karsten Kreis, Vancouver (CA); Luming Tang, New York, NY (US); Xiaohui Zeng, Torontoc (CA); Jun Gao, Toronto (CA); Xun Huang, Mountain View, CA (US); Towaki Takikawa, Toronto (CA)

(21) Appl. No.: 19/422,253

(22) Filed: Dec. 16, 2025

Related U.S. Application Data
(63) Continuation of application No. 18/232,279, filed on Aug. 9, 2023.
(60) Provisional application No. 63/425,932, filed on Nov. 16, 2022.

(51) Int. Cl. G06T 17/20; G06T 3/40; G06T 15/04; G06T 17/00; G06T 19/20

(52) U.S. Cl. CPC G06T 17/20; G06T 3/40; G06T 15/04; G06T 17/005; G06T 19/20

(57) ABSTRACT

Text-to-image generation generally refers to the process of generating an image from one or more text prompts input by a user. While artificial intelligence has been a valuable tool for text-to-image generation, current artificial intelligence-based solutions are more limited as it relates to text-to-3D content creation. For example, these solutions are oftentimes category-dependent, or synthesize 3D content at a low resolution. The present disclosure provides a process and architecture for high-resolution text-to-3D content creation.

### RELATED APPLICATION(S)

This application is a continuation application of U.S. application Ser. No. 18/232,279 (Attorney Docket No. NVIDP1364/22-SC-1441US02), titled “HIGH RESOLUTION TEXT-TO-3D CONTENT CREATION,” filed Aug. 9, 2023, which claims the benefit of U.S. Provisional Application No. 63/425,932 (Attorney Docket No. NVIDP1364+/22-SC-1441US01), titled “BOOSTING TEXT-TO-3D GENERATION” and filed Nov. 16, 2022, the entire contents of which is incorporated herein by reference.

### TECHNICAL FIELD

The present disclosure relates to processes for creating image content from text prompts.

### BACKGROUND

Text-to-image generation generally refers to the process of generating an image from one or more text prompts input by a user. This automated process has been developed as a solution to the otherwise difficult task of traditional content creation processes that generally require artistic training and, in the case of three-dimensional (3D) content, also require 3D modeling expertise. In particular, text-to-image generation processes allow content creation to be automated with natural language, thereby significantly reducing the skill required for the content creator. The text prompts can range from nouns, adjectives, artistic styles, etc.

Advances in artificial intelligence have provided significant progress for text-to-image generation, particularly by way of diffusion models for generative modeling of images. The key enablers of generative modeling of images are large-scale datasets comprising billions of samples of images with text which have been scraped from the Internet, as well as a massive amount of computations applied to those samples. Unfortunately, such large-scale datasets generally do not exist for 3D content, and as a result text-to-3D content creation processes have instead relied on 3D object generation models that are primarily categorical. This limitation means that a trained model can, in general, only be used to synthesize objects for a single class, thereby significantly limiting what a content creator can do with these types of models.

More recently, a solution has been developed which utilizes a pretrained text-to-image diffusion model as a strong prior for text-conditioned 3D content generation. However, this solution is trained on low resolution images and therefore cannot synthesize high-frequency 3D geometric and texture details. Moreover, this solution relies on an inefficient Multilayer Perceptron (MLP) architecture for a Neural Radiance Field (NeRF) representation of the 3D model, which means that practical high-resolution synthesis may not even be possible as the required memory footprint and the computation budget grows quickly with the resolution.

There is a need for addressing these issues and/or other issues associated with the prior art. For example, there is a need to provide high-resolution text-to-3D content creation.

### SUMMARY

A method, computer readable medium, and system are disclosed for high-resolution text-to-3D content creation. A 3D mesh is determined for a scene model generated with a first resolution, wherein the scene model is generated from an input text prompt describing a 3D content. The 3D mesh is processed, using a diffusion model, to predict a 3D mesh model with a second resolution that is greater than the first resolution.

### BRIEF DESCRIPTION OF THE DRAWINGS

FIG. 1 illustrates a method for high-resolution text-to-3D content creation, in accordance with an embodiment.

FIG. 2 illustrates a system operable to provide high-resolution text-to-3D content creation, in accordance with an embodiment.

FIG. 3 illustrates a method for using diffusion models to generate a 3D mesh model from an input text prompt, in accordance with an embodiment.

FIG. 4 illustrates a diffusion model-based system for generating a 3D mesh model from an input text prompt, in accordance with an embodiment.

FIG. 5 illustrates a method for user-controlled optimization of a 3D mesh model, in accordance with an embodiment.

FIG. 6A illustrates inference and/or training logic, according to at least one embodiment;

FIG. 6B illustrates inference and/or training logic, according to at least one embodiment;

FIG. 7 illustrates training and deployment of a neural network, according to at least one embodiment;

FIG. 8 illustrates an example data center system, according to at least one embodiment.

### DETAILED DESCRIPTION

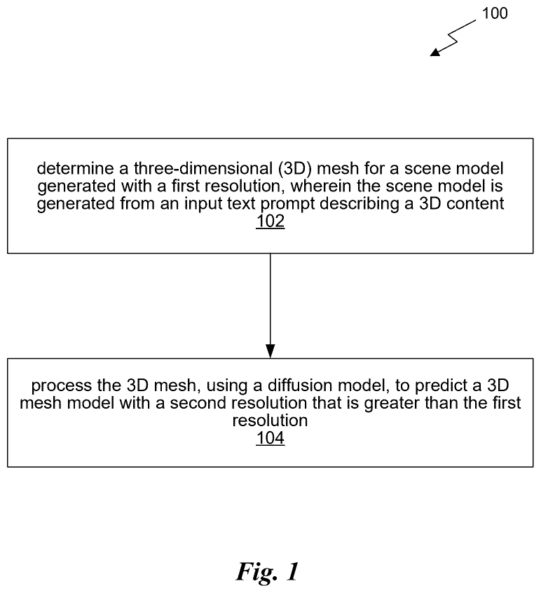

FIG. 1 illustrates a method 100 for high-resolution text-to-3D content creation, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, a 3D mesh is determined for a scene model generated with a first resolution, wherein the scene model is generated from an input text prompt describing a 3D content. The scene model refers to a model of a scene that has been generated from an input text prompt describing a 3D content. The input text prompt is a text (e.g. string) input by a user that describes the 3D content. For example, the text string may indicate one or more objects to be included in the scene, a size of the object(s), a color of the object(s), a placement of the object(s) in the scene and/or relative to one another, etc. In an embodiment, the model of the scene may also be generated from a reference image input by the user together with the text prompt. The reference image may depict an example of the object(s), in an embodiment.

In an embodiment, the scene model may be generated by a diffusion model (different from the diffusion model described below with respect to operation 104). In an embodiment, the diffusion model used to generate the scene model from the input text prompt may back-propagate gradients into the scene model via a loss defined on rendered images at the first resolution. In one exemplary embodiment, this diffusion model may be a pre-trained text-to-image diffusion model.

In an embodiment, the scene model may be a neural field representation (NeRF). In another embodiment, the scene model may be a coordinate-based multi-layer perceptron (MLP). For example, the coordinate-based MLP may predict albedo and density.

In yet another embodiment, the scene model may be an Instant-neural graphics primitive (Instant-NGP). In an embodiment, the Instant-NGP may use a hash grid encoding, and includes a first single-layer neural network that predicts albedo and density and a second single-layer neural network that predicts surface normal. Further related to this embodiment, a spatial data structure may be maintained that encodes scene occupancy and utilizes empty space skipping. Even further with respect to this embodiment, the scene model may be generated using density-based voxel pruning and an octree-based ray sampling and rendering algorithm.

As mentioned above, a 3D mesh is determined for the scene model. The 3D mesh refers to a 3D representation of the scene that is defined by a plurality of polygons. In an embodiment, the 3D mesh may be extracted from the scene model. For example, the 3D mesh may be determined using Deep Marching Tetrahedra (DMTet), which is a deep 3D conditional generative model.

Returning to the method 100, in operation 104, the 3D mesh is processed, using a diffusion model, to predict a 3D mesh model with a second resolution that is greater than the first resolution. The 3D mesh model refers to a 3D model that includes at least one 3D mesh. As mentioned, the 3D mesh model is defined with a second resolution that is greater than the first resolution.

In an embodiment, the 3D mesh model may be a deformable tetrahedral grid. Further to this embodiment, the deformable tetrahedral grid may include vertices in a grid, where each vertex contains a signed distance field value and a deformation of the vertex from its initial canonical coordinate. In an embodiment, the 3D mesh model may be textured. For example, a neural color field may be used as a volumetric texture representation for the 3D mesh model.

As already noted above, the diffusion model used to process the 3D mesh, and in turn to predict the 3D mesh model therefrom, is different from any diffusion model that may be used to generate the scene model from the input text prompt. In an embodiment, the diffusion model used to process the 3D mesh may be a latent diffusion model. In an embodiment, the diffusion model may back-propagate gradients into rendered images at the second resolution. In another embodiment, the diffusion model may process a latent code to predict the 3D mesh model, where resolution of the latent code is smaller than the second resolution.

To this end, the method 100 operates to predict, or compute or generate, a 3D mesh model of a 3D content described by an input text prompt. The method 100 relies on a scene model having a first resolution and operates to predict the 3D mesh model having the second (higher) resolution. For example, while the scene model may be generated with a 64×64 resolution, the 3D mesh model may be predicted with a 512×512 resolution. Accordingly, the method 100 provides high-resolution text-to-3D content creation.

In an optional embodiment, the method 100 may also include presenting the 3D content on a display device, using the 3D mesh model. For example, the 3D mesh model may be rendered (from a defined camera perspective) to an image that is presented on the display device. In an embodiment, a modification to the input text prompt may be received (from the user), and in turn the 3D mesh model may be optimized, or refined, based on the modification to the input text prompt. For example, the modification may be to a texture and/or a geometry, such that the corresponding texture and/or geometry of the 3D mesh model may be optimized accordingly.

Further embodiments will now be provided in the description of the subsequent figures. It should be noted that the embodiments disclosed herein with reference to the method 100 of FIG. 1 may apply to and/or be used in combination with any of the embodiments of the remaining figures below.

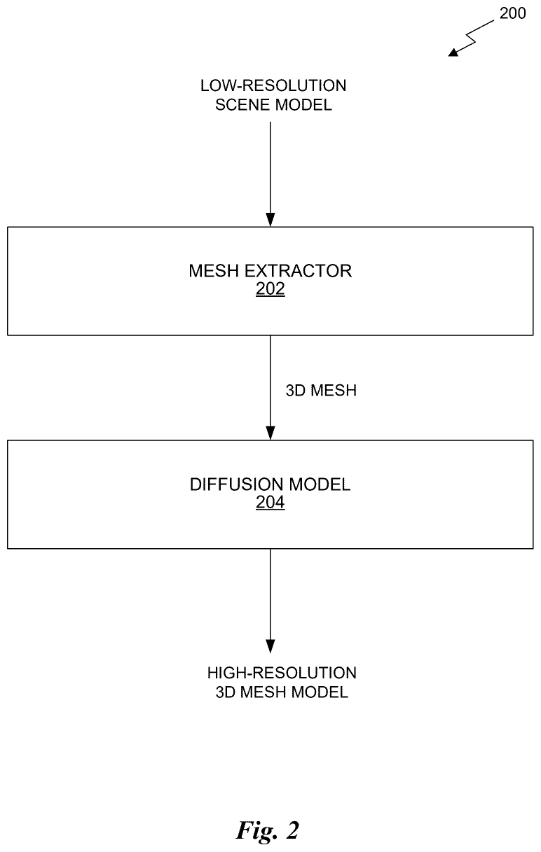

FIG. 2 illustrates a system 200 operable to provide high-resolution text-to-3D content creation, in accordance with an embodiment. The system 200 may be implemented to perform the method 100 of FIG. 1, in an embodiment. Of course, however, the system 200 may be implemented in any desired context. The definitions and embodiments described above may equally apply to the description of the present embodiment.

As shown, the system 200 includes at least a mesh extractor 202 and a diffusion model 204. It should be noted that in addition these components 202 and 204, other embodiments are also contemplated in which the system 200 includes other components which may be described herein. The system components may be implemented in hardware, software, or a combination thereof. Further, the system components may be implemented on a same computing device or across multiple different computing device.

With regard to the operation of the system 200, a low-resolution scene model is input to the mesh extractor 202. The low-resolution scene model refers to a scene model that has been generated from an input text prompt describing a 3D content. While the scene model is referred to as a “low-resolution” scene model, it should be noted that this simply refers to a resolution that is lower than a resolution of the output of the system 200, and in particular a resolution that is lower than a resolution of the 3D mesh model output by the diffusion model 204. In an embodiment, the low-resolution scene model may be generated by another diffusion model (not shown) that processes the input text prompt.

The mesh extractor 202 processes the low-resolution scene model to determine a 3D mesh for the low-resolution scene model. In an embodiment, the mesh extractor 202 may extract the 3D mesh from the low-resolution scene model. For example, the mesh extractor 202 may be a deep 3D conditional generative model that processes the low-resolution scene model to extract the 3D mesh therefrom.

The 3D mesh is output by the mesh extractor 202 to the diffusion model 204. The diffusion model 204 processes the 3D mesh to predict a high-resolution 3D mesh model. While the 3D mesh model is referred to as a “high-resolution” 3D mesh model, it should be noted that this simply refers to a resolution that is higher than a resolution of the input to the system 200, and in particular a resolution that is higher than a resolution of the scene model input to the mesh extractor 202.

The diffusion model 204 outputs the high-resolution 3D mesh model for use in presenting the 3D content on a display device (not shown). In an embodiment, the system 200 itself may use the 3D mesh model to present the 3D content on the display device. In another embodiment, the system 200 may output the 3D mesh model to a remote system for use in presenting the 3D content on the display device.

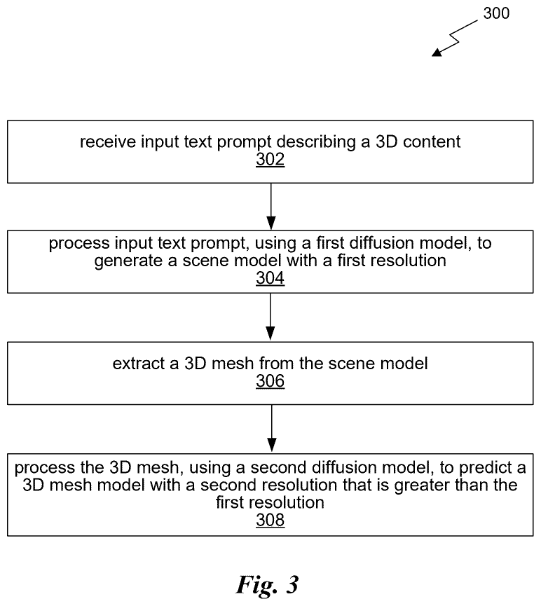

FIG. 3 illustrates a method 300 for using diffusion models to generate a 3D mesh model from an input text prompt, in accordance with an embodiment. The method 300 may be carried out, at least in part, using the system 200 described above. Of course, however, the method 300 may be carried out in any desired context. The definitions and embodiments described above may equally apply to the description of the present embodiment.

In operation 302, an input text prompt is received. The input text prompt includes text input by a user and describes a 3D content to be created. The input text prompt may be received via a user interface having a text box in which the text prompt can be entered. In an embodiment, a reference image may be received together with the input text prompt as an example of one or more objects indicated in the text prompt.

In operation 304, the input text prompt is processed, using a first diffusion model, to generate a scene model with a first resolution. In an embodiment, the first diffusion model may be a pre-trained text-to-image diffusion model. In an embodiment, the scene model may be an Instant-NGP representation of the 3D content.

In operation 306, a 3D mesh is extracted from the scene model. In operation 308, the 3D mesh is processed, using a second diffusion model, to predict a 3D mesh model with a second resolution that is greater than the first resolution. In an embodiment, the second diffusion model may be a latent diffusion model. In an embodiment, the 3D mesh model may be a deformable tetrahedral grid with vertices that each contain a signed distance field value and deformation of the vertex from its initial canonical coordinate. In an embodiment, the 3D mesh model may be textured, with a neural color field used as a volumetric texture representation.

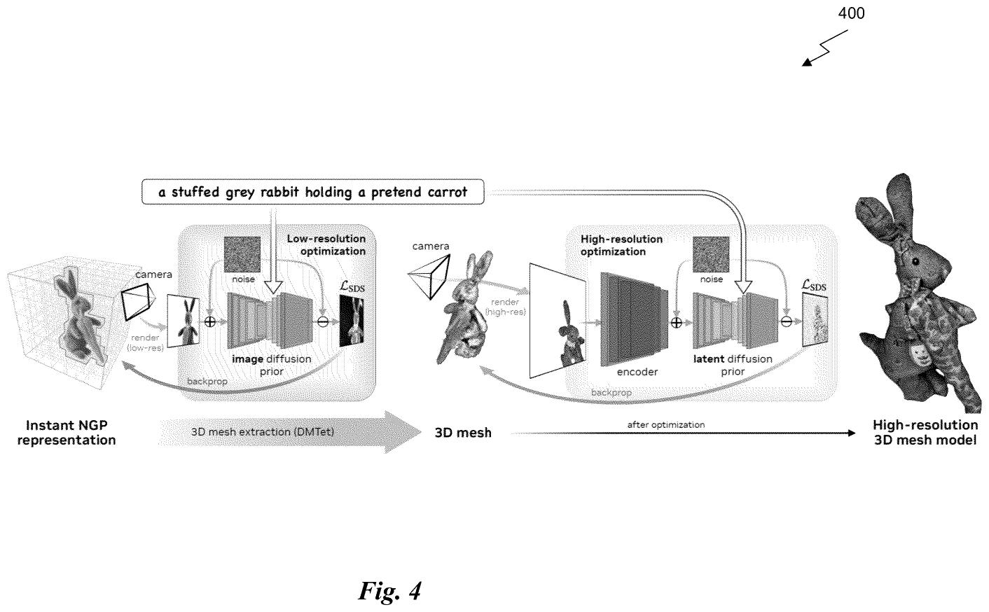

FIG. 4 illustrates a diffusion model-based system 400 for generating a 3D mesh model from an input text prompt, in accordance with an embodiment. The system 400 may be implemented to perform the method 300 of FIG. 3, in an embodiment. Of course, however, the system 400 may be implemented in any desired context. The definitions and embodiments described above may equally apply to the description of the present embodiment.

The system 400, as illustrated, is a two-stage coarse-to-fine framework that uses efficient scene models that enable high-resolution text-to-3D synthesis.

### Coarse-to-Fine Diffusion Models

The system 400 uses two different diffusion models in a coarse-to-fine fashion to generate high-resolution geometry and textures. In a first stage, an image diffusion model is used to backpropagate gradients into the scene model via a loss defined on rendered images at a low resolution (e.g. 64×64). In a second stage, a latent diffusion model is used which allows backpropagating gradients into rendered images at a high resolution (e.g. 512×512). Despite generating high-resolution images, the computation of the latent diffusion model is manageable because the model acts on the latent zₜ with the low resolution, per Equation 1.

$${∇}_{θ} {ℒ}_{S D S} ( ∅ , g ( θ ) ) = {𝔼}_{t , ϵ} [ w ( t ) ( {ϵ}_{∅} ( {z}_{t} ; y , t ) - ϵ ) \frac{{\partial }_{z}}{{\partial }_{x}} \frac{{\partial }_{x}}{{\partial }_{θ}} ] \qquad Equation 1$$

where g is a volumetric renderer, θ is a coordinate-based MLP representing a 3D volume, Ø is a diffusion model with a learned denoising function ϵ_{Ø}(zₜ; y, t) that predicts the sampled noise E given the noisy image zₜ, noise level t, and text embedding y.

$$\frac{{\partial }_{x}}{{\partial }_{0}}$$

is the gradient of the high-resolution rendered image and

$$\frac{{\partial }_{z}}{{\partial }_{x}}$$

is the gradient of the encoder.

### Scene Models

The system 400 caters two different 3D scene representations to the two different diffusion models at coarse (low) and fine (high) resolutions to accommodate the increased resolution of image renders from the high-resolution models, as follows.

### Neural Fields as Coarse (Low Resolution) Scene Models

The initial coarse stage of optimization requires finding the geometry and textures from scratch. This can be challenging in order to accommodate complex topological changes in the 3D geometry and depth ambiguities from the 2D signals. In an embodiment, the scene model is a neural field (a coordinate-based MLP) that predicts albedo and density. This is a suitable choice as neural fields can handle topology changes in a smooth, continuous fashion.

In an embodiment, a hash grid encoding from Instant-NGP is used, which allows high-frequency details to be represented at a low computational cost. The hash grid may be used with two single-layer neural networks, one predicting albedo and density and the other predicting surface normals. A spatial data structure may be maintained which encodes scene occupancy and utilizes empty space skipping. Specifically, a density-based voxel pruning approach from Instant-NGP may be used with an octree-based ray sampling and rendering algorithm.

With these design choices, the optimization of coarse scene models is drastically optimized while maintaining quality.

### Textured Meshes as Fine (High Resolution) Scene Models

In the fine stage of optimization, very high-resolution rendering is accommodated to fine-tune the scene model with high-resolution diffusion priors. Using the same scene representation (the neural field) from the initial coarse stage of optimization could be a natural choice since the weights of the model can directly carry over. Although this strategy can work to some extent (FIG. 4), it struggles to render very high-resolution (e.g., 512×512) images within reasonable memory constraints and computation budgets.

To address these issues, textured 3D meshes are used as the scene representation for the fine stage of optimization. In contrast to neural fields, textured meshes with rasterization are capable of efficiently rendering at very high resolutions, making them a suitable choice for the high-resolution optimization stage. Using the neural field from the coarse stage as the initialization for the mesh geometry, the difficulty of learning large topological changes of meshes can be uniquely sidestepped. More formally, the 3D shape is represented using a deformable tetrahedral grid, denoted as (VT, T), where I′T are the vertices in the grid T. Each vertex, vᵢ∈V′, vᵢ∈ [symbol] ³, contains a signed distance field (SDF) value sᵢ∈ [symbol] and a deformation Δvᵢ∈R³ of the vertex from its initial canonical coordinate. For textures, the neural color field is used as a volumetric texture representation.

### Coarse-to-Fine Optimization

Returning to the coarse-to-fine optimization process illustrated in FIG. 4, the process first operates on a coarse neural field representation and, subsequently, a high-resolution textured mesh.

### Neural Field Optimization

Similarly to Instant NGP, an occupancy grid (e.g. of resolution 2563) is initialized with values (e.g. to 20) to encourage shapes to grow in the early stages of optimization. The grid is updated every (e.g. 10) iterations and generates an octree for empty space skipping. The occupancy grid is decayed (e.g. by 0.6) in every update, and Instant NGP is followed with the same update and thresholding parameters.

Instead of estimating surface normals from density differences, an MLP is used to predict the normals. Note that this does not violate geometric properties since volume rendering is used instead of surface rendering; as such, the orientation of particles at continuous positions need not be oriented to the level set surface. This helps to significantly reduce the computational cost of optimizing the coarse model. Accurate normals can be obtained in the fine stage of optimization when using a true surface rendering model.

The background is modeled using an environment map MLP, which predicts red, blue, green (RGB) colors as a function of ray directions. Since the sparse representation model does not support scene reparametrization, the optimization has a tendency to “cheat” by learning the essence of the object using the background environment map. As such, a tiny MLP is used for the environment map (e.g. with a hidden dimension size of 16) and the learning rate is weighted down (e.g. by 10×) to allow the model to focus more on the neural field geometry.

### Mesh Optimization

To optimize a mesh from the neural field initialization, the (coarse) density field to an is converted to an SDF by subtracting with a non-zero constant, yielding the initial sᵢ. The volume texture field is initialized directly with the color field optimized from the coarse stage.

During optimization, a surface mesh is obtained from the SDF using a differentiable marching tetrahedra algorithm and rendered into high-resolution images using a differentiable rasterizer. Both sᵢ and Δvᵢ are optimized for each vertex vᵢ via backpropagation using the high resolution Score Distillation Sampling (SDS) loss. When rendering the mesh to an image, the 3D coordinates of each corresponding pixel projection is tracked, for use to query colors in the corresponding texture field for joint optimization.

To render the mesh, a camera and lighting is randomly sampled (as for the neural field), except the focal length is increased to zoom in on object details. Increasing the focal length is a critical step towards recovering high frequency details. The same pretrained environment map is kept from the coarse stage of optimization and the rendered background is composited with the rendered foreground object using differentiable antialiasing. To encourage the smoothness of the surface, the angular differences between adjacent faces on the mesh are regularized. This allows well-behaved geometry to be obtained even under noisy supervision signals, such as the SDS loss.

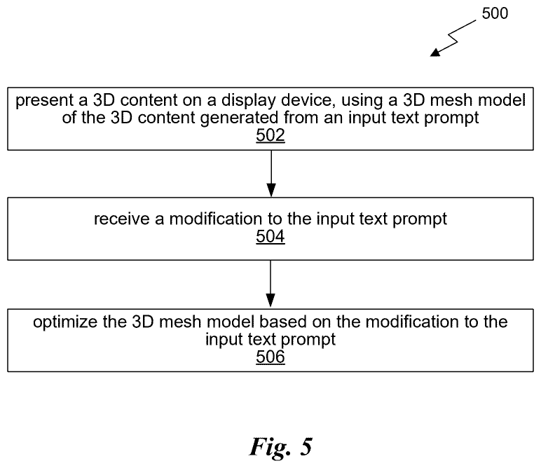

FIG. 5 illustrates a method 500 for user-controlled optimization of a 3D mesh model, in accordance with an embodiment. The method 500 may be carried out in the context of the embodiments described above. For example, the method 500 may be carried out once the 3D mesh model is created via the method 100 of FIG. 1. Of course, however, the method 500 may be carried out in any desired context. The definitions and embodiments described above may equally apply to the description of the present embodiment.

In operation 502, a 3D content is presented on a display device, using a 3D mesh model of the 3D content generated from an input text prompt. The input text prompt is provided by a user to cause the 3D content to be generated. In an embodiment, the 3D mesh model may be rendered (from a defined camera perspective) to an image that is presented on the display device.

In operation 504, a modification to the input text prompt is received. The modification may be received from the user mentioned above or from a different user. The modification may received as a new input text prompt that changes one or more parameters of the prior input text prompt, in an embodiment. For example, the modification may be to a texture and/or a geometry of the 3D content. As another example, the modification may be adding a reference image to the input text prompt.

In operation 506, the 3D mesh model is optimized (or refined) based on the modification to the input text prompt. In the example above where the modification is to a texture and/or a geometry of the 3D content, the corresponding texture and/or geometry of the 3D mesh model may be optimized accordingly. In the example above where the modification is the addition of the reference image, the 3D mesh model may be optimized to better match the object(s) in the reference image.

It should be noted that the 3D mesh model may be repeatedly optimized by the user, per the method 500, as desired. As certain styles and concepts are difficult to express in words but easy with images, the method 500 provides users with a mechanism to influence the text-to-3D model generation, for example with reference images.

### Various Embodiments for User-Controlled Optimization

### Personalized Text-to-3D

In the context of text-to-3D generation, a 3D model of a subject is generated. This can be achieved by first fine-tuning a pretrained model on several images of a subject. The fine-tuned model can learn to tie the subject to a unique identifier string, denoted as [V], and generate images of the subject when [V] is included in the text prompt. Furthermore, once the model is fine-tuned, it can also be used with the [V] identifier as part of the conditioning text prompt to provide the learning signal when optimizing the 3D model.

### Style-Guided Text-to-3D

As mentioned above, the diffusion model is designed in a way that it can condition on a reference image when performing text-to-image generation. Such an image conditioning design makes it easy to change the style of the generated output. However, we find that

Naively feeding a style (reference) image as input to the diffusion model when computing the SDS loss can result in a poor 3D model that is essentially overfitting to the input image, which may be caused by the conditioning signal provided via the image being significantly stronger than the text prompt during optimization. To better balance the guidance strength between image and text conditioning the model's classifier-free guidance scheme is extended and the final \tilde{ϵ}_{Ø}(zₜ; yₜₑₓₜ>y_{image}, t) is computed per Equation 2:

$$\tilde{ϵ} ( {z}_{t} ; {y}_{text} , {y}_{image} , t ) = {ϵ}_{∅} ( {z}_{t} ; t ) + {w}_{text} [ {ϵ}_{∅} ( {z}_{t} ; {y}_{text} ) - {ϵ}_{∅} ( {z}_{t} ; t ) ] + {w}_{joint} [ {ϵ}_{∅} ( {z}_{t} ; {y}_{text} , {y}_{image} ) - {ϵ}_{∅} ( {z}_{t} ; t ) ] \qquad Equation 2$$

where yₜₑₓₜ and y_{image} are text and image conditionings, respectively.

### Prompt Editing Through Fine-Tuning

Another way to control the generated 3D content is by fine-tuning a learned coarse model with a new prompt. The prompt editing includes three stages: (i) train a coarse model with a base prompt. (ii) Modify the base prompt and fine-tune the coarse model with LDM. This stage provides a good initialized NeRF model for the next step. Directly applying mesh optimization on a new prompt generates highly detailed textures but can only deform geometry slightly. (iii) Optimize the mesh with the modified text prompt. The prompt editing can modify the texture of the shape or transform the geometry and texture according to the text. The resulting scene model will preserve the layer-out and overall structure. Such an editing capability makes the 3D content creation more controllable.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

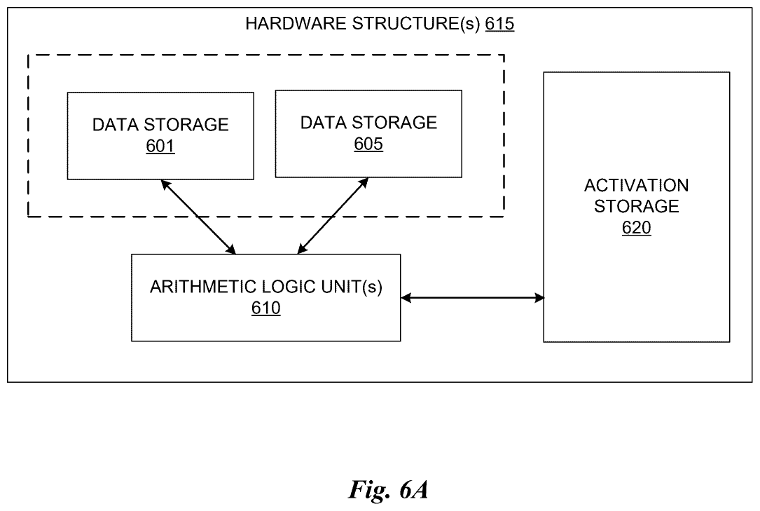

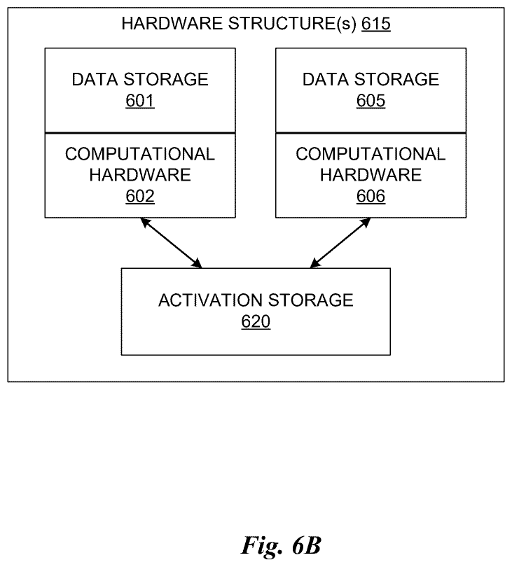

As noted above, a deep learning or neural learning system needs to be trained to generate inferences from input data. Details regarding inference and/or training logic 615 for a deep learning or neural learning system are provided below in conjunction with FIGS. 6A and/or 6B.

In at least one embodiment, inference and/or training logic 615 may include, without limitation, a data storage 601 to store forward and/or output weight and/or input/output data corresponding to neurons or layers of a neural network trained and/or used for inferencing in aspects of one or more embodiments. In at least one embodiment data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 601 may be included with other on-chip or off-chip data storage, including a processor's L1, L2, or L3 cache or system memory.

In at least one embodiment, any portion of data storage 601 may be internal or external to one or more processors or other hardware logic devices or circuits. In at least one embodiment, data storage 601 may be cache memory, dynamic randomly addressable memory (“DRAM”), static randomly addressable memory (“SRAM”), non-volatile memory (e.g., Flash memory), or other storage. In at least one embodiment, choice of whether data storage 601 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 may include, without limitation, a data storage 605 to store backward and/or output weight and/or input/output data corresponding to neurons or layers of a neural network trained and/or used for inferencing in aspects of one or more embodiments. In at least one embodiment, data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 605 may be included with other on-chip or off-chip data storage, including a processor's L1, L2, or L3 cache or system memory. In at least one embodiment, any portion of data storage 605 may be internal or external to on one or more processors or other hardware logic devices or circuits. In at least one embodiment, data storage 605 may be cache memory, DRAM, SRAM, non-volatile memory (e.g., Flash memory), or other storage. In at least one embodiment, choice of whether data storage 605 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 601 and data storage 605 may be separate storage structures. In at least one embodiment, data storage 601 and data storage 605 may be same storage structure. In at least one embodiment, data storage 601 and data storage 605 may be partially same storage structure and partially separate storage structures. In at least one embodiment, any portion of data storage 601 and data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610 to perform logical and/or mathematical operations based, at least in part on, or indicated by, training and/or inference code, result of which may result in activations (e.g., output values from layers or neurons within a neural network) stored in an activation storage 620 that are functions of input/output and/or weight parameter data stored in data storage 601 and/or data storage 605. In at least one embodiment, activations stored in activation storage 620 are generated according to linear algebraic and or matrix-based mathematics performed by ALU(s) 610 in response to performing instructions or other code, wherein weight values stored in data storage 605 and/or data 601 are used as operands along with other values, such as bias values, gradient information, momentum values, or other parameters or hyperparameters, any or all of which may be stored in data storage 605 or data storage 601 or another storage on or off-chip. In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 601, data storage 605, and activation storage 620 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., Flash memory), or other storage. In at least one embodiment, activation storage 620 may be completely or partially within or external to one or more processors or other logical circuits. In at least one embodiment, choice of whether activation storage 620 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 615 illustrated in FIG. 6A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, data storage 601 and data storage 605, which may be used to store weight values and/or other information, including bias values, gradient information, momentum values, and/or other parameter or hyperparameter information. In at least one embodiment illustrated in FIG. 6B, each of data storage 601 and data storage 605 is associated with a dedicated computational resource, such as computational hardware 602 and computational hardware 606, respectively. In at least one embodiment, each of computational hardware 606 comprises one or more ALUs that perform mathematical functions, such as linear algebraic functions, only on information stored in data storage 601 and data storage 605, respectively, result of which is stored in activation storage 620.

In at least one embodiment, each of data storage 601 and 605 and corresponding computational hardware 602 and 606, respectively, correspond to different layers of a neural network, such that resulting activation from one “storage/computational pair 601/602” of data storage 601 and computational hardware 602 is provided as an input to next “storage/computational pair 605/606” of data storage 605 and computational hardware 606, in order to mirror conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage computation pairs 601/602 and 605/606 may be included in inference and/or training logic 615.

### Neural Network Training and Deployment

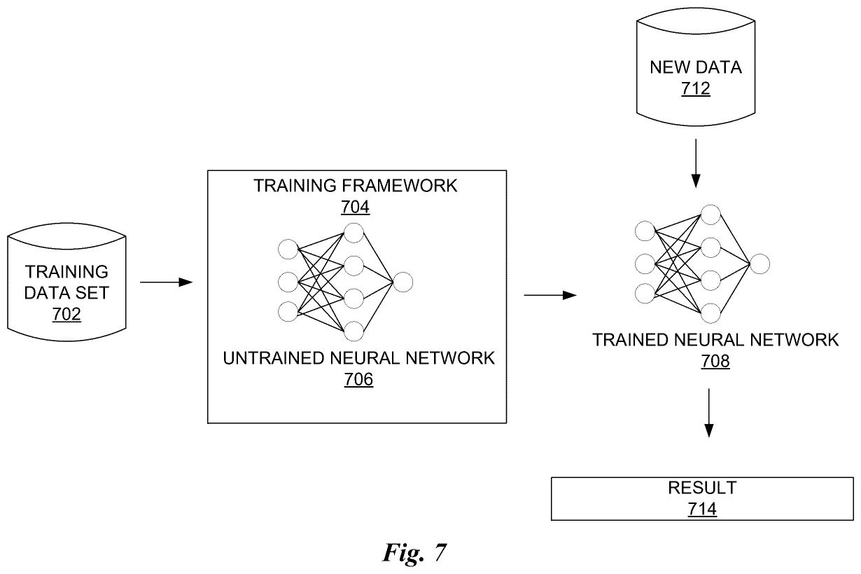

FIG. 7 illustrates another embodiment for training and deployment of a deep neural network. In at least one embodiment, untrained neural network 706 is trained using a training dataset 702. In at least one embodiment, training framework 704 is a PyTorch framework, whereas in other embodiments, training framework 704 is a Tensorflow, Boost, Caffe, Microsoft Cognitive Toolkit/CNTK, MXNet, Chainer, Keras, Deeplearning4j, or other training framework. In at least one embodiment training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having known output and the output of the neural network is manually graded. In at least one embodiment, untrained neural network 706 is trained in a supervised manner processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on known input data, such as new data 712. In at least one embodiment, training framework 704 trains untrained neural network 706 repeatedly while adjust weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map, which is a type of trained neural network 708 capable of performing operations useful in reducing dimensionality of new data 712. In at least one embodiment, unsupervised training can also be used to perform anomaly detection, which allows identification of data points in a new dataset 712 that deviate from normal patterns of new dataset 712.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new data 712 without forgetting knowledge instilled within network during initial training.

### Data Center

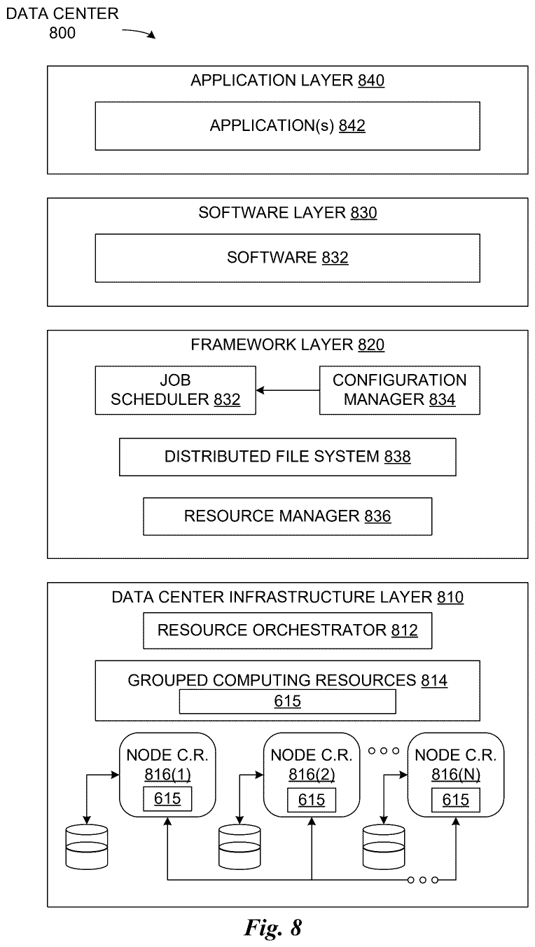

FIG. 8 illustrates an example data center 800, in which at least one embodiment may be used. In at least one embodiment, data center 800 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 822 may configure or otherwise control one or more node C.R.s 816(1)-816(N) and/or grouped computing resources 814. In at least one embodiment, resource orchestrator 822 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 832, a configuration manager 834, a resource manager 836 and a distributed file system 838. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. In at least one embodiment, configuration manager 834 may be capable of configuring different layers such as software layer 830 and framework layer 820 including Spark and distributed file system 838 for supporting large-scale data processing. In at least one embodiment, resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. In at least one embodiment, resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 8 for inferencing or predicting operations based, at least in part, on weight parameters calculated using neural network training operations, neural network functions and/or architectures, or neural network use cases described herein.

As described herein with reference to FIGS. 1-5, a method, computer readable medium, and system are disclosed for high-resolution text-to-3D content creation, which relies on a diffusion model. The diffusion model may be stored (partially or wholly) in one or both of data storage 601 and 605 in inference and/or training logic 615 as depicted in FIGS. 6A and 6B. Training and deployment of the diffusion model may be performed as depicted in FIG. 7 and described herein. Distribution of the diffusion model may be performed using one or more servers in a data center 800 as depicted in FIG. 8 and described herein.

What is claimed is:

1. A method comprising:
at a device:
determining a three-dimensional (3D) mesh for a scene model generated with a first resolution, wherein the scene model is generated from an input text prompt describing a 3D content; and
processing the 3D mesh, using a diffusion model, to predict a 3D mesh model with a second resolution that is greater than the first resolution;
wherein the 3D mesh model is textured and wherein a neural color field is used as a volumetric texture representation for the 3D mesh model.

2. The method of claim 1, wherein the text prompt is input by a user.

3. The method of claim 2, wherein the scene model is further generated based on a reference image input by the user together with the text prompt.

4. The method of claim 1, wherein the scene model is a neural field representation.

5. The method of claim 1, wherein the scene model is generated by another diffusion model that back-propagates gradients into the scene model via a loss defined on rendered images at the first resolution.

6. The method of claim 5, wherein the other diffusion model is a pre-trained text-to-image diffusion model.

7. The method of claim 1, wherein the scene model is a coordinate-based multi-layer perceptron (MLP).

8. The method of claim 7, wherein the coordinate-based MLP predicts albedo and density.

9. The method of claim 1, wherein the scene model is an Instant-neural graphics primitive (Instant-NGP).

10. The method of claim 9, wherein the Instant-NGP uses a hash grid encoding, and includes a first single-layer neural network that predicts albedo and density and a second single-layer neural network that predicts surface normals.

11. The method of claim 10, wherein a spatial data structure is maintained that encodes scene occupancy and utilizes empty space skipping.

12. The method of claim 11, wherein the scene model is generated using density-based voxel pruning and an octree-based ray sampling and rendering algorithm.

13. The method of claim 1, wherein the 3D mesh is extracted from the scene model.

14. The method of claim 1, wherein the diffusion model is a latent diffusion model.

15. The method of claim 1, wherein the diffusion model back-propagates gradients into rendered images at the second resolution.

16. The method of claim 1, wherein the diffusion model processes a latent code to predict the 3D mesh model, and wherein a resolution of the latent code is smaller than the second resolution.

17. The method of claim 1, wherein the 3D mesh model is a deformable tetrahedral grid.

18. The method of claim 17, wherein the deformable tetrahedral grid includes vertices in a grid, wherein each vertex contains a signed distance field value and a deformation of the vertex from its initial canonical coordinate.

19. The method of claim 1, wherein the first resolution is 64×64.

20. The method of claim 1, wherein the second resolution is 512×512.

21. The method of claim 1, further comprising, at the device:
presenting the 3D content on a display device, using the 3D mesh model.

22. The method of claim 21, further comprising, at the device:
receiving a modification to the input text prompt; and
optimizing the 3D mesh model based on the modification to the input text prompt.

23. The method of claim 22, wherein the modification is to a texture.

24. The method of claim 22, wherein the modification is to a geometry.

25. A system, comprising:
a non-transitory memory storage comprising instructions; and
one or more processors in communication with the memory, wherein the one or more processors execute the instructions to:
determine a three-dimensional (3D) mesh for a scene model generated with a first resolution, wherein the scene model is generated from an input text prompt describing a 3D content; and
process the 3D mesh, using a diffusion model, to predict a 3D mesh model with a second resolution that is greater than the first resolution.

26. A non-transitory computer-readable media storing computer instructions which when executed by one or more processors of a device cause the device to:
determine a three-dimensional (3D) mesh for a scene model generated with a first resolution, wherein the scene model is generated from an input text prompt describing a 3D content; and
process the 3D mesh, using a diffusion model, to predict a 3D mesh model with a second resolution that is greater than the first resolution.
